(19) United States
(12) Patent Application Publication
(10) Pub. No.: US 2025/0219706 A1
(43) Pub. Date: Jul. 3, 2025

(54) Beam Control Method Using Multi-Sensor in Millimeter-Wave and Terahertz-Wave Wireless Communication System, and Recording Medium and Device for Performing Same

(71) Applicant: SEOUL NATIONAL UNIVERSITY R&DB FOUNDATION, Seoul (KR)

(72) Inventors: Byonghyo Shim, Seoul (KR); Yongjun Ahn, Seoul (KR); Jinhong Kim, Seoul (KR); Junhan Kim, Seoul (KR); Seungnyun Kim, Seoul (KR); Kyuhong Shim, Seoul (KR); Jiyoung Kim, Seoul (KR)

(21) Appl. No.: 18/850,547

(22) PCT Filed: Apr. 21, 2023
(86) PCT No.: PCT/KR2023/005452

§ 371 Date: Sep. 24, 2024

(30) Foreign Application Priority Data
Apr. 26, 2022 (KR) 10-2022-0051257

(51) Int. Cl. H04B 7/06; H04W 64/00

(52) U.S. Cl. CPC H04B 7/06952; H04B 7/0626; H04W 64/00

(57) ABSTRACT

A beam control method using a multi-sensor in a millimeter-wave and terahertz-wave wireless communication system comprises the steps of: diving a beamforming region and performing beam sweeping by a base station; specifying, through beam sweeping, a divided region in which the strength of a received signal is the strongest; obtaining image information through at least one sensor included in a wireless terminal or a base station located in the specified divided region; identifying a target terminal to be communicated, by using the obtained image information, and extracting location information of the identified target terminal; and transmitting data in a direction corresponding to the location information of the identified target terminal. Accordingly, it is possible to greatly increase the accuracy of beamforming in a wireless communication environment, and reduce power consumption, a radio resource overhead, and a delay time required for beamforming.

### TECHNICAL FIELD

The disclosure relates to a method of controlling a beam using a multi-sensor in a millimeter-wave and terahertz-wave wireless communication system, and a recording medium and a device for performing the same and, more particularly, to a technology for extracting channel information from measurement values of a multi-sensor, such as an RGB-D camera, LiDAR, radar, and an ultrasonic sensor, and controlling a millimeter-wave and terahertz-wave beam by using the same.

### BACKGROUND ART

Due to the explosive demand and expectations for virtual/augmented reality (VR/AR), autonomous vehicles, metaverse, and Internet of Everything (IoE) technologies, wireless communication technologies are recently required to significantly improve the performance beyond the current level in various aspects such as connectivity, data transmission rate, reliability, and delay time.

In order to meet such requirements, a 5^{th} generation mobile communication that has been recently commercialized uses sufficient frequency resources in a millimeter-wave (mmWave) band. A 6^{th} generation mobile communication system that is just beginning to be studied recently aims at constructing a wireless communication network which is more advanced in terms of speed and reliability by using frequency resources not only in a millimeter-wave band but also in a terahertz-wave (THz wave) band.

Main challenges of a millimeter-wave and terahertz-wave band wireless communication system lie in solving various problems occurring due to physical characteristics (limitations) of radio waves.

Unlike the microwave band used in long-term evolution (LTE) that is traditional 4^{th} generation mobile communication, the millimeter-wave and terahertz-wave band has short wavelengths and very strong straightness and thus has a large propagation loss due to path loss, diffraction, penetration, and the like. In order to compensate for the loss, the 5G NR system has used a beamforming technology that concentrates transmission signals from antennas to a direction of a receiver that desires the transmission signals.

The distance between the transmitter and the receiver, angle information, and the like are needed to perform the beamforming scheme. As described above, the millimeter wave and terahertz wave have the large power loss due to diffraction and penetration, and thus power of radio waves starting from a transmitting side is concentrated on the line of sight (LOS) wave, and the non-line of sight (NLOS) wave component is very weak.

Since beamforming is performed by concentrating all transmission power in a direction of the straight wave, there is a problem that radio waves are blocked if an obstacle randomly enters a physical path between the transmitter and the receiver. Accordingly, in order to prevent communication failure, the cause of the propagation loss should be detected, and a wireless connection is required to switch to an adjacent BS, a relay, or the like where a straight wave path exits.

The conventional scheme requires continuous signal exchange to estimate the distance and angle between various base stations (BSs) and the terminal and detect surrounding environment information (obstacle locations and the like), so there are limits in that it is realistically very difficult to implement the scheme in future communication systems.

### DETAILED DESCRIPTION OF THE INVENTION

### Technical Problem

Technical problems of the disclosure were conceived to overcome the limitations, and an aspect of the disclosure is to provide a beam control method using a multi-sensor in a millimeter-wave and terahertz-wave wireless communication system.

Another aspect of the disclosure is to provide a recording medium that records computer programs for performing the beam control method using the multi-sensor in the millimeter-wave and terahertz-wave wireless communication system.

Yet another aspect of the disclosure is to provide a device for performing the beam control method using the multi-sensor in the millimeter-wave and terahertz-wave wireless communication system.

### Technical Solution

A beam control method using a multi-sensor in a millimeter-wave and terahertz-wave wireless communication system according to an embodiment for realizing the aspect of the disclosure includes diving a beamforming region and performing beam sweeping by a base station; specifying, through beam sweeping, a divided region in which the strength of a received signal is the strongest; obtaining image information through at least one sensor included in a wireless terminal or a base station located in the specified divided region; identifying a target terminal to be communicated, by using the obtained image information, and extracting location information of the identified target terminal; and transmitting data in a direction corresponding to the location information of the identified target terminal.

In an embodiment of the disclosure, the transmitting of the data in the direction corresponding to the location information of the identified target terminal may further include, in case that direct data cannot be transmitted to the target terminal, transmitting data to at least one of a relay, a small cell, an intelligence reflecting surface, and a WiFi access point.

In an embodiment of the disclosure, the identifying of the target terminal to be communicated by using the obtained image information and extracting of the location information of the identified target terminal may further include extracting confidence information indicated by an error rate or a margin of error.

In an embodiment of the disclosure, the location information of the target terminal to be communicated may be location information of the target terminal received from channel state information (CSI) or a beam index feedback.

In an embodiment of the disclosure, the location information of the target terminal to be communicated may include at least one of a distance, an azimuth angle, and an elevation angle.

In an embodiment of the disclosure, the identifying of the target terminal to be communicated by using the obtained image information and extracting of the location information of the identified target terminal may further include performing pre-processing of processing the obtained image information through signal processing or machine learning technology.

A computer-readable storage medium according to an embodiment for realizing another aspect of the disclosure records computer programs to perform the method of controlling the beam using the multi-sensor in the millimeter-wave and terahertz-wave wireless communication system.

An device for controlling a beam using a multi-sensor in a millimeter-wave and terahertz-wave wireless communication system according to an embodiment for realizing another aspect of the disclosure includes a beam sweeping unit configured to divide a beamforming region and perform beam sweeping by a base station (BS), a divided region-specifying unit configured to specify a divided region in which the strength of a received signal is the strongest through beam sweeping, an information acquisition unit configured to obtain image information through at least one sensor included in the BS or a wireless terminal located in the specified divided region, an object identification and location extraction unit configured to identify a target terminal to be communicated by using the obtained image information and extract location information of the identified target unit, and a data transmitter configured to transmit data in a direction corresponding to the location information of the identified target terminal.

In an embodiment of the disclosure, the data transmitter may be configured to, in case that direct data cannot be transmitted to the identified target terminal, transmit data to at least one of a relay, a small cell, an intelligence reflecting surface, and a WiFi access point.

In an embodiment of the disclosure, the object identification and location extraction unit may be configured to perform pre-processing of processing the obtained image information through a signal processing or machine learning technology and extract confidence information indicated by an error rate or a margin of error.

### Advantageous Effects

According to the beam control method using the multi-sensor in the millimeter-wave and terahertz-wave wireless communication system, channel information is extracted from a measurement value of a sensor and millimeter-wave and terahertz-wave beams are controlled in detail using the channel information. Accordingly, the disclosure can extract wireless environment information with the high accuracy from an image captured by the BS or sensing information received therefrom without any separate radio wave transmission and reception, thereby significantly increasing the accuracy of beamforming. Simultaneously, the disclosure can greatly reduce the control signal overhead that was the problem in the conventional communication system and also greatly shorten the transmission and reception delay time.

### BRIEF DESCRIPTION OF DRAWINGS

FIG. 1 is a block diagram of a beam control device using a multi-sensor in a millimeter-wave and terahertz-wave wireless communication system according to an embodiment of the disclosure.

FIG. 2 is a diagram illustrating a process in which a BS performs beamforming.

FIG. 3 is a diagram illustrating a process in which a divided region-specifying unit of FIG. 1 specifies a divided region in which the strength of a received signal is the strongest through beam sweeping.

FIG. 4 is a diagram illustrating a process in which an object identification and location extraction unit of FIG. 1 identifies a target terminal to be communicated by using obtained image information and extracts location information of the identified target terminal.

FIG. 5 is a diagram illustrating a process of obtaining a pair of best transmission and reception beams through feedback received as a beamforming result of FIG. 4.

FIG. 6 is a flowchart of a beam control method using a multi-sensor in a millimeter-wave and terahertz-wave wireless communication system according to an embodiment of the disclosure.

### MODE FOR CARRYING OUT THE INVENTION

In the detailed description of the disclosure set forth below, reference is to be made to the accompanying drawings, provided as examples of particular embodiments by which the disclosure can be realized. The embodiments are described in sufficient detail to enable those skilled in the art to realize the disclosure. It should be understood that various embodiments of the disclosure are different from each other but do not need to be exclusive from each other. For examples, specific shapes, structures, and characteristics described herein may be implemented as another embodiment in connection with an embodiment without departing from the spirit and scope of the disclosure. Further, it should be understood that locations or arrangement of individual elements within each of the disclosed embodiments can be modified without departing from the spirit and scope of the disclosure. Accordingly, the detailed description below does not intend to have limited meanings, and the scope of the disclosure is limited by the appended claims in addition to all ranges equivalent to the claims if the scope is appropriately described. In the drawings, similar reference numerals refer to the same as or similar functions throughout various aspects.

Hereinafter, exemplary embodiments of the disclosure are described in more detail with reference to the drawings.

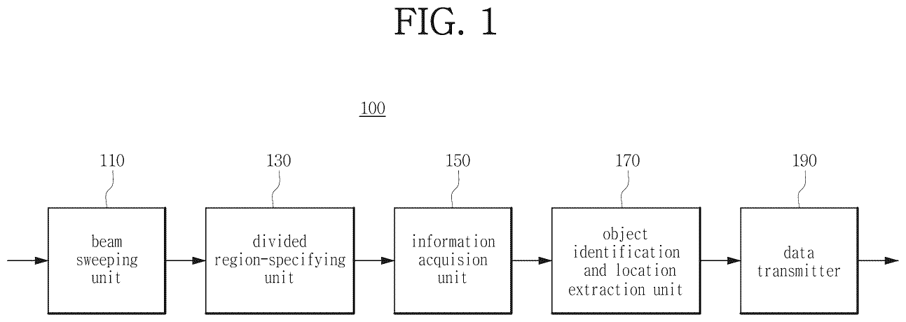

FIG. 1 is a block diagram of a beam control device using a multi-sensor in a millimeter-wave and terahertz-wave wireless communication system according to an embodiment of the disclosure.

A beam control device 100 (hereinafter, referred to as a device) using a multi-sensor in a millimeter-wave and terahertz-wave wireless communication system according to the disclosure may directly identify radio environment information, such as a location, an angle, and a distance of a receiver, from sensor information obtained using sensing and artificial intelligence technology beyond a method of feeding back a channel or a beam index after transmitting the conventional pilot, and then perform beam control.

Particularly, since the accuracy of an image classification/segmentation scheme has significantly increased with the recent development of sensing technology, higher resolution beamforming may be performed compared to the conventional pilot/beam index feedback-based beamforming. Further, through the disclosure, it is possible to perform beamforming within a much short time, compared to the conventional beam control technology.

Referring to FIG. 1, the device 100 according to the disclosure includes a beam sweeping unit 110, a divided region-specifying unit 130, an information acquisition unit 150, an object identification and location extraction unit 170, and a data transmitter 190.

The device 100 of the disclosure may constitute a part of a base station (BS) or may be included in the BS.

In the device 100 of the disclosure, software (application) for performing beam control using the multi-sensor in the millimeter-wave and terahertz-wave wireless communication system may be installed and executed, and the configuration of the beam sweeping unit 110, the divided region-specifying unit 130, the information acquisition unit 150, the object identification and location extraction unit 170, and the data transmitter 190 may be controlled by the software for performing beam control using the multi-sensor in the millimeter-wave and terahertz-wave wireless communication system executed in the device 100.

The device 100 may be a separate terminal or a partial module of the terminal. Further, elements such as the beam sweeping unit 110, the divided region-specifying unit 130, the information acquisition unit 150, the object identification and location extraction unit 170, and the data transmitter 190 may be formed as an integrated module or one or more modules. However, on the contrary to this, each element may be constituted by a separate module.

The device 100 may have mobility or may be fixed. The device 100 may be in the form of a server or an engine, and may be called another term such as a device, an apparatus, a terminal, a user equipment (UE), a mobile station (MS), a wireless device, or a handheld device.

The device 100 may execute or manufacture various software, based on an operating system (OS), that is, a system. The operating system is a system program for allowing the software to use hardware of the device and may include all of mobile computer operating systems such as Android, OS, iOS, Window mobile OS, Bada OS, Symbian, and BlackBerry OS, and computer operating systems such as Window series, Linux series, Unix series, MAC, AIX, and HP-UX.

The disclosure proposes a technology using signal processing and artificial intelligence for extracting radio environment information from measurement values of various sensors, such as LiDAR, laser, images, and ultrasonic waves, and a technology using the extracted information for a communication system.

Recently, with a quantum leap of deep learning (DL) and artificial intelligence (AI), the artificial intelligence technology is being used in various fields, such as image classification/segmentation based on images, videos, and voice processing technology, and natural language processing (NLP).

In the disclosure, object detection for finding a wireless device or a terminal that receives information from sensing information such as images, LiDAR, and laser, and object localization for finding location information such as a distance and an angle are performed through machine learning and a signal processing scheme, or a combination thereof.

Specifically, in the disclosure, a distance between a transmitter and a receiver, an angle, and information on surrounding terrain are extracted from sensing information obtained from an imaging sensor (an RGB-D camera, LiDAR, or the like), LiDAR, laser, or an ultrasonic sensor, and millimeter-wave and terahertz-wave beams are controlled using the same.

Particularly, beamforming, radio wave blocking prediction, handover, and the like may be performed using three-dimensional location information of transmitters, receivers, and obstacles (exterior wall of a building, a moving object, and the like) extracted from a relay having a multi-sensor installed therein, a small cell, an intelligent reflecting surface, and a WiFi access point, and the like.

The beam sweeping unit 110 in the BS divides a beamforming region and performs beam sweeping, and the divided region-specifying unit 130 specifies a divided region in which the strength of a received signal is the strongest through beam sweeping.

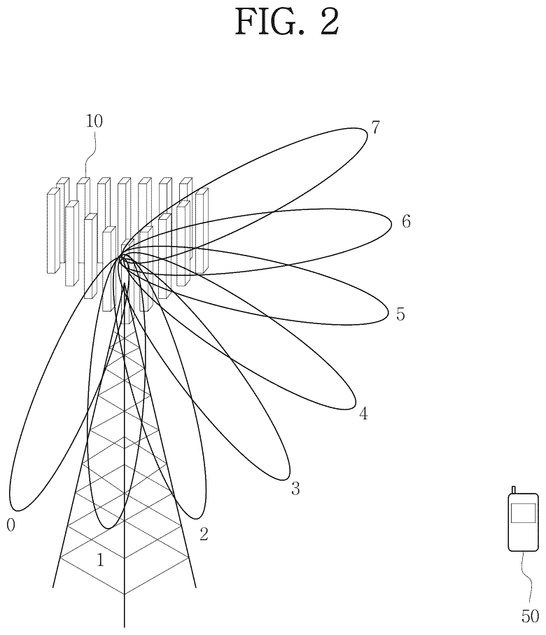

Referring to FIG. 2, a BS 10 obtains approximate location and angle information of a terminal 50 through initial access to the terminal 50.

The BS 10 specifies a sensing region around the accessed terminals, and then obtains sensing information of images and the like in the corresponding region.

The BS processes the sensor information through the signal processing or machine learning technology and obtains accurate location information (ρ,θ,ϕ) of the terminal. The location information may be indicated in a spherical coordinate system format or a Cartesian coordinate system format expressed by, for example, a distance, an azimuth angle, and an elevation angle.

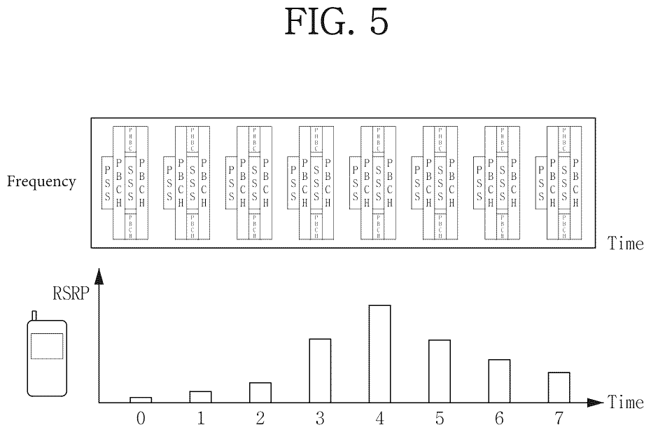

The BS calculates a beamforming codeword having a high resolution (exactly facing a direction of the terminal) by substituting the obtained location information into [Equation 1] to [Equation 3] below (see FIG. 5). The BS 10 transmits data to the terminal 50 by using the high-resolution beamforming codeword.

$${a}_{y} ( θ , ∅ ) = {[ 1 , {e}^{j π sin ( θ ) sin ( ∅ )} , … , {e}^{− j π ( {N}_{y} − 1 ) sin ( θ ) sin ( ∅ )} ]}^{T} \qquad [ Equation 1 ]$$

$${a}_{z} ( θ , ∅ ) = {[ 1 , {e}^{j π cos ( ∅ )} , … , {e}^{− j π ( {N}_{z} − 1 ) cos ( ∅ )} ]}^{T} \qquad [ Equation 2 ]$$

$$w = {a}_{y} ( θ , ∅ ) ⊕ {a}_{z} ( ∅ ) \qquad [ Equation 3 ]$$

Hereinafter, an embodiment of transferring surrounding environment information obtained from the sensor to the BS and controlling beamforming between the BS 10 and a single terminal, based on the surrounding environment information, is described.

An embodiment in which the BS 10 has antennas in a uniform planar array form having the size of Nᵤ×Nₓ is described through an example, and the disclosure can be applied to antenna arrays in various forms.

First, the BS 10 obtains location information (ρ,θ,ϕ) of the terminal by processing sensor information through signal processing or machine learning technology. The location information is indicated in a spherical coordinate system format or a Cartesian coordinate system format expressed by (distance, azimuth angle, elevation angle).

Only for the region in which the terminal is located, the BS 10 calculates K beamforming codewords having a high resolution (facing subdivided angle regions) by using [Equation 1] to [Equation 3] and gathers them to configure a beamforming codebook W.

The BS 10 sequentially performs beam sweeping according to the beamforming codeword during K symbols, and the terminal 50 feeds back an index i of a beam in which the strength of a received signal is the strongest for the beamforming codebook to the BS (a fourth index in FIG. 5).

The BS 10 transmits data to the terminal by using the fed back high-resolution beamforming codeword wᵢ.

Hereinafter, an embodiment of transferring surrounding environment information obtained from the sensor to the BS 10 and controlling beamforming between the BS 10 and two or more terminals, based on the surrounding environment information, is described.

An embodiment in which the BS 10 has antennas in a uniform planar array form having the size of Nᵤ×Nₓ is described through an example, and the disclosure can be applied to antenna arrays in various forms.

It is assumed that the number of terminals is M, and the terminals are indicated as terminal 1, terminal 2, . . . terminal M. The terminal indication order may be randomly changed.

First, the BS 10 obtains M pieces of location information (p₁, θ₁, ∅₁, . . . , (p_{M}, θ_{M}, ∅_{M}) by processing sensor information through signal processing or machine learning technology. The location information is indicated in a spherical coordinate system format or a Cartesian coordinate system format expressed by (distance, azimuth angle, elevation angle).

The BS 10 transmits a synchronization signal in directions of M terminals and obtains IDs of the respective terminals through initial access.

Based on IDs of transmission terminals, the BS 10 calculates K beamforming codewords (facing subdivided angle regions) having a high resolution in the direction of each terminal by using [Equation 4] below and gathers them to configure the beamforming codebook W as shown in [Equation 5] below.

$${w}_{k} = {α}_{y} ( {θ}_{k} , {∅}_{k} ) ⊕ {a}_{z} ( {∅}_{k} ) \qquad [ Equation 4 ]$$

$$W = [ {W}_{1} , … , {W}_{K} ] \qquad [ Equation 5 ]$$

The BS 10 sequentially performs beam sweeping for each terminal according to the beamforming codeword during K symbols. Each terminal feeds back the index i of the beam in which the strength of a received signal is the strongest to the BS.

The BS 10 transmits data to each terminal by using the fed back high-resolution beamforming codeword wᵢ.

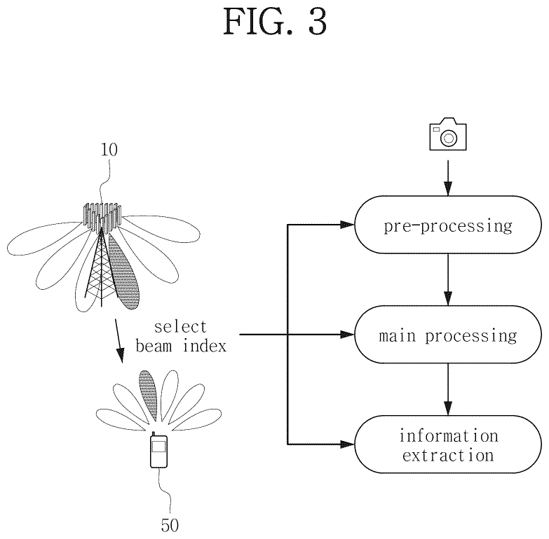

Referring to FIG. 3, the divided region-specifying unit 130 specifies a divided region in which the strength of a received signal is the strongest through beam sweeping. For example, the divided region-specifying unit 130 may apply the signal processing or machine learning technology to process sensor information.

A signal processing process for processing the sensor information may be applied via a process, such as pre-processing, main processing, and information extraction, and each process may be separated into more subdivided steps or may be omitted.

When the artificial intelligence technology is applied to the RGB camera-based sensor, a pre-processing process of removing noise or removing non-region of interest and the like may be performed. Other additional technologies may be used.

In the main processing process, extraction of an object such as the terminal receiving a signal or the like, depth calculation, and object tracking may be performed, and the final output of the signal processing process may be location information, an object ID, confidence information (for example, an error rate or the margin of error), and the like, and other additional information that can help communication may be transmitted.

In an embedment, the sensor may periodically (for example, 0.1 seconds) capture images, videos, and the like and transmit the same to the BS. Unlike this, when an event is generated, images and the like may be captured and transmitted to the BS.

The information acquisition unit 150 obtains sensing information such as image information through at least one sensor included in the BS or a wireless terminal located in a specific divided region.

Specifically, the information acquisition unit 150 is installed in the BS or the wireless terminal and uses sensor information to obtain information such as a physical angle, distance, 3D-shape, or the like of a region to which a radio signal is transmitted.

For example, the sensor may be an RGB-D camera, a thermal imaging camera, radar, LiDAR, or the like, but is not limited thereto. In the disclosure, the sensor is interchangeably used with a “camera” as the most representative example of the sensor, but it is not limited to the camera (RGB camera or the like) having the conventional sense and may be equally applied to all of the sensors described above.

The number and the type of sensors may be variously designated and, even when a plurality of sensors is used, the sensors do not need to be of the same type.

At a predetermined time (for example, every second interval) or when a situation of interest (for example, user's movement) is generated, the camera may obtain information on the region and transmit the information to an embedded or a separate calculation device.

The disclosure is not limited to the use by the BS, and may be used for a terminal having a sensor installed therein, a relay, a small cell, an intelligent reflecting surface, a WiFi access point, a drone having transmission and reception equipment, and the like.

For example, after several RGB-D cameras are installed in the notebook, beamforming may be directly performed in the notebook or distance and angle information from the receiver may be fed back to the BS.

The object identification and location extraction unit 170 identifies a target terminal to be communicated by using obtained image information and extract location information of the identified target terminal.

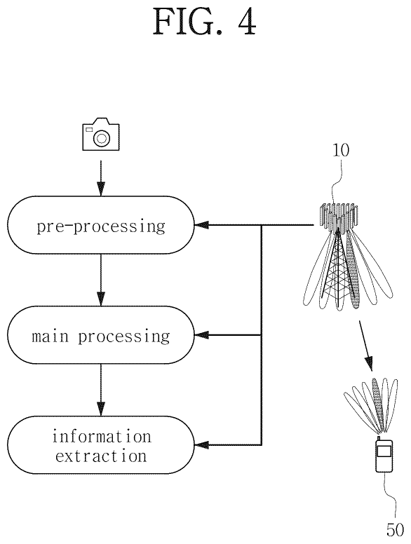

Referring to FIG. 4, the object identification and location extraction unit 170 extracts location information of an object that helps for communication by using the signal processing or machine learning scheme from the information obtained from the information acquisition unit 150.

The signal processing and machine learning technology may use, for example, a software-based algorithm, deep learning, and artificial intelligence, but are not limited thereto.

An object or a region related to communication to be found may be (1) equipment including a wireless communication device, a smartphone, an electronic device, a vehicle, a flight vehicle such as a drone, and the like. Further, the object or the region may be (2) an obstacle that may interrupt wireless communication, a wall, a building, a tree, and the like, and (3) equipment that outputs and collects wireless communication signals, another BS, a WiFi access point, and the like, but is not limited to the above examples.

The location information is a location relative to the BS or the terminal or a location in an absolute space, and may be provided in various forms like a Cartesian coordinate system (x,y,z) information, spherical coordinate system (p, θ, ∅)information, GPS information, and the like

In a processing of specifying location information, information on confidence of the location estimated by the signal processing technology may be provided along with the location information. For example, confidence information may be expressed by an error rate or the margin of error.

For example, the object identification and location extraction unit 170 may apply the signal processing or machine learning technology to process sensor information. A signal processing process for processing the sensor information may be applied via a process, such as pre-processing, main processing, and information extraction, and each process may be separated into more subdivided steps or may be omitted.

Hereinafter, the case where the RGB camera is used as the sensor, that is, the case where RGB images are input as the input of the signal processing or machine learning scheme is described as an example.

In a first step, it is possible to more easily preprocess processing in a future step by enhancing the quality of an input image. In the process, various artificial intelligence-based technologies, such as non-region of interest or noise removal, fog/rain/snow removal, lens obstacle removal, super resolution conversion, and low-light enhancement, may be used.

In a second step, it is possible to obtain more accurate information by correcting distortion of the camera (fix camera distortion) and combining a plurality of pieces of camera information to make one large image. In the step, various artificial intelligence-based technologies, such as image stitching, image warping, fixing barrel distorting, and fixing rolling shutter distortion, may be used.

In a third step, core location information may be extracted from the image. Through object detection technology, locations of main objects, such as a person, a smartphone, a vehicle, a drone, and an intelligent reflecting surface, may be obtained in a box form (bounding box). The obtained box information may include box location information, information on the type (class) of an object inside the box, and confidence information of the box.

Object detection may use an artificial neural network structure such as a CNN, and receives one frame or a plurality of recent frames as an input and identifies a bounding box for an object existing in the image.

Further, through depth estimation technology, it is possible to calculate how far each pixel in the image is from the camera. When a single RGB camera is used, the relative distance may be corrected to the absolute distance through the distance from pre-obtained reference points, and when a plurality of RGB cameras is used, the absolute distance may be calculated using the distance between the cameras and a change in an image. Depth estimation may output the final result by combining pre-obtained hardware information and information predicated by the CNN-based artificial neural network.

Further, through the object tracking technology, the location to which the same object moves in the image may be determined. The object tracking may use a rule-based algorithm, such as Kalman filtering of computer vision, or the CNN-based artificial neural network, and may output a bounding box location and each bounding box ID corrected using one frame or a plurality of recent image frames and predicted bounding box information together as inputs. The object tracking may be used to correct bounding box information and also provide an estimated value for a direction in which the object will move in the future.

In an additional step, useful additional information other than the location may be extracted. In the step, various artificial intelligence-based technologies, such as pedestrian count, crowd density estimation, and reliability calculation (uncertainty estimation), may be used.

The data transmitter 190 transmits data in a direction corresponding to location information of the identified target terminal.

In the disclosure, after location information of the target terminal to be communicated may be accurately identified through the extracted location information of the terminal, the data may be directly transmitted in the direction of the identified target terminal. Based on this, beamforming between the BS and the terminal may be effectively controlled.

Accordingly, a transmitting side can immediately transmit a beam to a target receiving side, that is, a location of the receiving side estimated by the sensor, without any beam training process, track a movement path of the target receiver, and preemptively transmit the beam in a direction in which the target terminal (receiver) moves.

Further, when there are obstacles that block radio waves or when the target terminal is hidden from a direct propagation path of the BS, the location information of the target terminal may be provided to another BS that can directly transmit radio waves to the target terminal, a relay, a small cell, an intelligent reflecting surface, a WiFi access point, and the like.

In addition, when the information extracted from the sensor is processed through the signal processing or machine learning technology, better location information may be specified additionally using communication information obtained from the BS or the terminal.

In the disclosure, after narrowing a sensing region (for example, a camera capturing region) by using location information of the receiver (for example, the target terminal) received from channel state information (CSI) or beam index feedback, the transmitter (for example, the BS) may form the high-resolution beam in a direction of the receiver by using the machine learning or signal processing technology from sensed information in the corresponding region.

As another embodiment of the disclosure, it is possible to perform high-resolution beamforming by performing beam sweeping in the selected narrow region after narrowing the direction of the receiver by first using sensing information.

The BS or the terminal may form the high-resolution beam by using the received channel state information or beam index feedback after transmitting several beams (beam sweeping) of dividing the narrow area in the detected receiver direction into details by using location information and confidence information obtained through the signal processing.

The disclosure may be expected to improve the performance in both aspects of accuracy and beam resolution of the sensor information processing technology by alternately using the two technologies of FIGS. 3 and 4.

Specifically, after an region to be obtained by the sensor is specified based on location information of the terminal obtained during the initial access process between the BS 10 and the terminal 50, high-resolution beamforming is performed in the corresponding region.

With the advent of the 4^{th} industrial revolution, demands on future-oriented technologies, such as virtual/augmented reality and ultra-high definition streaming that simultaneously require a high data transmission rate and a very low transmission time are expected to continuously increase.

The international telecommunication union (ITU) predicts that demands on data in the future 6G era (2030s) will increase at least 20 times compared to the current demands on data in 2022, and accordingly, demands on communication technology markets are expected to continuously grow.

As the solution of coping with the explosive increase in demand, the disclosure proposes a future-oriented communication paradigm in a new direction that combines computer vision, artificial intelligence/signal processing-based technology, and a communication system.

The disclosure mainly aims at the millimeter-wave and terahertz-wave beam control technology that is an essential element of the 6G era coming in the future, and the technology has extremely high utility value since it is a key transmission and reception technology for greatly improving a transmission rate.

Particularly, the beam control and the artificial/signal processing-based image classification/segmentation corresponding to the main interests of the disclosure are being continuously studied and commercialized in wireless communication and artificial intelligence fields, so the commercial feasibility of the disclosure is also very high.

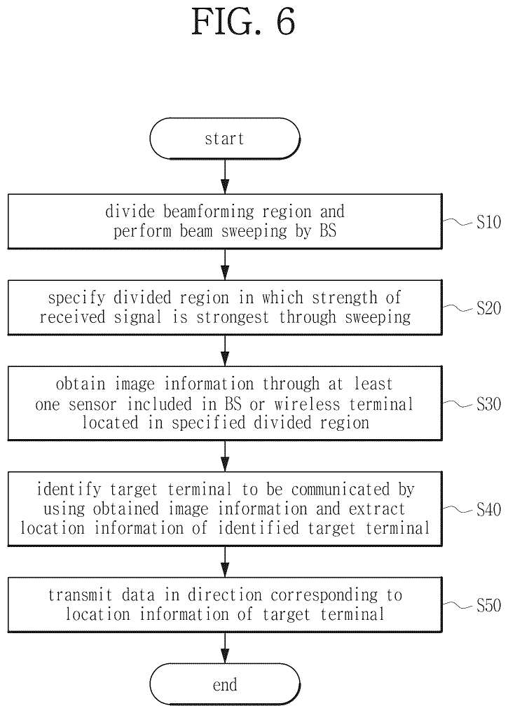

FIG. 6 is a flowchart of a beam control method using a multi-sensor in a millimeter-wave and terahertz-wave wireless communication system according to an embodiment of the disclosure.

The beam control method using the multi-sensor in the millimeter-wave and terahertz-wave wireless communication system according to the embodiment may be performed in substantially the same configuration as the device 100 of FIG. 1. Accordingly, the same elements of the device 100 of FIG. 1 may be assigned the same reference numeral, and duplicate description is omitted.

The beam control method using the multi-sensor in the millimeter-wave and terahertz-wave wireless communication system according to the embodiment may be performed by software (application) for performing the beam control using the multi-sensor in the millimeter-wave and terahertz-wave wireless communication system.

The disclosure may perform the beam control after identifying radio environment information, such as a location, an angle, and a distance of the receiver, directly from sensor information obtained using the sensing and artificial intelligence technology beyond a method of feeding back a channel or a beam index after conventionally transmitting a pilot signal or a synchronization signal (SSB of SG).

Particularly, since the accuracy of an image classification/segmentation scheme has significantly increased with the recent development of sensing technology, higher resolution beamforming may be performed compared to the conventional pilot/beam index feedback-based beamforming. Through the disclosure, it is possible to perform beamforming within a much short time, compared to the conventional beam control technology.

Referring to FIG. 6, the method using the multi-sensor in the millimeter-wave and terahertz-wave wireless communication system according to the embodiment divides a beamforming region by the BS and performs beam sweeping in S10, and specifies a divided region in which the strength of a received signal is the strongest through the beam sweeping in S20.

For example, the signal processing or machine learning technology may be used for processing sensor information. A signal processing process for processing the sensor information may be applied via a process, such as pre-processing, main processing, and information extraction, and each process may be separated into more subdivided steps or may be omitted.

When the artificial intelligence technology is applied to the RGB camera-based sensor, a pre-processing process of removing noise or removing non-region of interest and the like may be performed. Other additional technologies may be used.

In the main processing process, extraction of an object such as the terminal receiving a signal or the like, depth calculation, and object tracking may be performed, and the final output of the signal processing process may be location information, an object ID, confidence information (for example, an error rate or the margin of error), and the like, and other additional information that can help communication may be transmitted.

In an embedment, the sensor may periodically (for example, 0.1 seconds) capture images, videos, and the like and transmit the same to the BS. Unlike this, when an event is generated, images and the like may be captured and transmitted to the BS.

Thereafter, image information is obtained through at least one sensor included in the BS or the wireless terminal located in the specified divided region in S30.

For example, the sensor may be an RGB-D camera, a thermal imaging camera, radar, LiDAR, or the like, but is not limited thereto. In the disclosure, the sensor is interchangeably used with a “camera” as the most representative example of the sensor, but it is not limited to the camera (RGB camera or the like) having the conventional sense and may be equally applied to all of the sensors described above.

The number and the type of sensors may be variously designated and, even when a plurality of sensors is used, the sensors do not need to be of the same type.

At a predetermined time (for example, every second interval) or when a situation of interest (for example, user's movement) is generated, the camera may obtain information on the region and transmit the information to an embedded or a separate calculation device.

The disclosure is not limited to the use by the BS, and may be used for a terminal having a sensor installed therein, a relay, a small cell, an intelligent reflecting surface, a WiFi access point, a drone having transmission and reception equipment, and the like.

For example, after several RGB-D cameras are installed in the notebook, beamforming may be directly performed in the notebook or distance and angle information from the receiver may be fed back to the BS.

Location information of the target terminal to be communicated is identified using the obtained image information and location information of the identified target terminal is extracted in S40. At this time, location information of an object that helps for communication may be extracted using the signal processing or machine learning scheme for the obtained information.

The signal processing and machine learning technology may use, for example, a software-based algorithm, deep learning, and artificial intelligence, but are not limited thereto.

An object or a region related to communication to be found may be (1) equipment including a wireless communication device, a smartphone, an electronic device, a vehicle, a flight vehicle such as a drone, and the like. Further, the object or the region may be (2) an obstacle that may interrupt wireless communication, a wall, a building, a tree, and the like, and (3) equipment that outputs and collects wireless communication signals, another BS, a WiFi access point, and the like, but is not limited to the above examples.

The location information is a location relative to the BS or the terminal or a location in an absolute space, and may be provided in various forms like a Cartesian coordinate system (x,y,z) information, spherical coordinate system (ρ,θ,ϕ) information, GPS information, and the like

In a processing of specifying location information, confidence information of the location estimated by the signal processing technology may be provided along with the location information. For example, confidence information may be expressed by an error rate or the margin of error.

For example, the signal processing or machine learning technology may be used for processing sensor information. A signal processing process for processing the sensor information may be applied via a process, such as pre-processing, main processing, and information extraction, and each process may be separated into more subdivided steps or may be omitted.

In a first step, it is possible to more easily preprocess processing in a future step by enhancing the quality of an input image. In the process, various artificial intelligence-based technologies, such as non-region of interest or noise removal, fog/rain/snow removal, lens obstacle removal, super resolution conversion, and low-light enhancement, may be used.

In a second step, it is possible to obtain more accurate information by correcting distortion of the camera (fix camera distortion) and combining a plurality of pieces of camera information to make one large image. In the step, various artificial intelligence-based technologies, such as image stitching, image warping, fixing barrel distorting, and fixing rolling shutter distortion, may be used.

In a third step, core location information may be extracted from the image. Through object detection technology, locations of main objects, such as a person, a smartphone, a vehicle, a drone, and an intelligent reflecting surface, may be obtained in a box form (bounding box). The obtained box information may include box location information, information on the type (class) of an object inside the box, and confidence information of the box.

Object detection may use an artificial neural network structure such as a CNN, and receives one frame or a plurality of recent frames as an input and identifies a bounding box for an object existing in the image.

Further, through depth estimation technology, it is possible to calculate how far each pixel in the image is from the camera. When a single RGB camera is used, the relative distance may be corrected to the absolute distance through the distance from pre-obtained reference points, and when a plurality of RGB cameras is used, the absolute distance may be calculated using the distance between the cameras and a change in an image. Depth estimation may output the final result by combining pre-obtained hardware information and information predicated by the CNN-based artificial neural network.

Further, through the object tracking technology, the location to which the same object moves in the image may be determined. The object tracking may use a rule-based algorithm, such as Kalman filtering of computer vision, or the CNN-based artificial neural network, and may output a bounding box location and each bounding box ID corrected using one frame or a plurality of recent image frames and predicted bounding box information together as inputs. The object tracking may be used to correct bounding box information and also provide an estimated value for a direction in which the object will move in the future.

In an additional step, useful additional information other than the location may be extracted. In the step, various artificial intelligence-based technologies, such as pedestrian count, crowd density estimation, and uncertainty estimation, may be used.

The data is transmitted in a direction corresponding to the location information of the identified target terminal in S50.

In the disclosure, after location information of the target terminal to be communicated may be accurately identified through the extracted location information of the terminal, the data may be directly transmitted in the direction of the identified target terminal. Based on this, beamforming between the BS and the terminal may be effectively controlled.

Accordingly, a transmitting side can immediately transmit a beam to a target receiving side, that is, a location of the receiving side estimated by the sensor, without any beam training process, track a movement path of the target receiver, and preemptively transmit the beam in a direction in which the target terminal (receiver) moves.

Further, when there are obstacles that block radio waves or when the target terminal is hidden from a direct propagation path of the BS, the location information of the target terminal may be provided to another BS that can directly transmit radio waves to the target terminal, a relay, a small cell, an intelligent reflecting surface, a WiF access point, and the like.

In addition, when the information extracted from the sensor is processed through the signal processing or machine learning technology, better location information may be specified additionally using communication information obtained from the BS or the terminal.

In the disclosure, after narrowing a sensing region (for example, a camera capturing region) by using location information of the receiver (for example, the target terminal) received from channel state information (CSI) or beam index feedback, the transmitter (for example, the BS) may form the high-resolution beam in a direction of the receiver by using the machine learning or signal processing technology from sensed information in the corresponding region.

As another embodiment of the disclosure, it is possible to perform high-resolution beamforming by performing beam sweeping in the selected narrow region after narrowing the direction of the receiver by first using sensing information.

The BS or the terminal may form the high-resolution beam by using the received channel state information or beam index feedback after transmitting several beams (beam sweeping) of dividing the narrow region in the detected receiver direction into details by using location information and confidence information obtained through the signal processing.

The conventional mobile communication system used a radio frequency (RF) to detect a transmission environment (radio channel) between the transmitter and the receiver.

However, the disclosure extracts channel information from the measurement value of the sensor and control the millimeter-wave and terahertz-wave beam by using the same. The disclosure relates to a technology for facilitating super-high frequency (millimeter or terahertz band) communication using a multi-sensor, and may be used for various mobile communications including 6G mobile communication.

The beam control method using the multi-sensor in the millimeter-wave and terahertz-wave wireless communication system may be implemented by an application or in the form of a program command that can be executed through various computer components and thus may be recorded in a computer-readable recording medium. The computer-readable recording medium may include a program command, a data file, a data structure, and the like, either alone or in a combination thereof.

The program command recorded in the computer-readable recording medium may be specially designed and configured for the disclosure, and may be used after being known to those skilled in computer software fields.

Examples of the computer-readable recording medium include magnetic media such as hard disks, floppy disks and magnetic tapes, optical recording media such as a compact disc read-only memory (CD-ROM) and a digital versatile disc (DVD), magneto-optical media such as floptical disks, and hardware devices such as a read-only memory (ROM), a random access memory (RAM) and a flash memory, which are specially configured to store and execute program commands.

Examples of the program command include not only a machine language code made by a compiler but also a high-level language code executable by a computer using an interpreter and the like. The hardware devices may be configured to operate as one or more software modules to perform processing according to the disclosure, and vice versa.

The above description has been made with reference to embodiments, but those skilled in the art can understand that the disclosure may be variously modified and changed without departing from the sprit and scope of the disclosure pertaining to the appended claims.

### INDUSTRIAL APPLICABILITY

A multi-sensor-based beam control scheme and device proposed in the disclosure can be widely applied to all communication systems using beamforming. Particularly, the disclosure can be applied to 6G Internet of Everything that requires multiple and low-latency connectivity, virtual/augmented reality that requires a high data transmission rate, a vehicle communication environment that requires super-high reliability and low latency, and the like.

1. A beam control method using a multi-sensor in a millimeter-wave and terahertz-wave wireless communication system, the beam control method comprising:
dividing a beamforming region and performing beam sweeping by a base station (BS);
specifying a divided region in which a strength of a received signal is a strongest through beam sweeping;
obtaining image information through at least one sensor included in the BS or a wireless terminal located in the specified divided region;
identifying a target terminal to be communicated by using the obtained image information and extracting location information of the identified target terminal; and
transmitting data in a direction corresponding to the location information of the identified target terminal.

2. The beam control method of claim 1, wherein the transmitting of the data in the direction corresponding to the location information of the identified target terminal further comprises, in case that direct data cannot be transmitted to the target terminal, transmitting data to at least one of a relay, a small cell, an intelligence reflecting surface, and a WiFi access point.

3. The beam control method of claim 1, wherein the identifying of the target terminal to be communicated by using the obtained image information and extracting of the location information of the identified target terminal further comprises extracting confidence information indicated by an error rate or a margin of error.

4. The beam control method of claim 1, wherein the location information of the target terminal to be communicated is location information of the target terminal receiving channel state information (CSI) or a beam index feedback.

5. The beam control method of claim 1, wherein the location information of the target terminal to be communicated comprises at least one of a distance, an azimuth angle, and an elevation angle.

6. The beam control method of claim 1, wherein the identifying of the target terminal to be communicated by using the obtained image information and extracting of the location information of the identified target terminal further comprises performing pre-processing of processing the obtained image information through signal processing or machine learning technology.

7. A non-transitory computer-readable storage medium recording computer programs to perform the beam control method of controlling the beam using the multi-sensor in the millimeter-wave and terahertz-wave wireless communication system of claim 1.

8. A beam control device using a multi-sensor in a millimeter-wave and terahertz-wave wireless communication system, the beam control device comprising:
a beam sweeping unit configured to divide a beamforming region and perform beam sweeping by a base station (BS);
a divided region-specifying unit configured to specify a divided region in which a strength of a received signal is a strongest through beam sweeping;
an information acquisition unit configured to obtain image information through at least one sensor included in the BS or a wireless terminal located in the specified divided region;
an object identification and location extraction unit configured to identify a target terminal to be communicated by using the obtained image information and extract location information of the identified target terminal; and
a data transmitter configured to transmit data in a direction corresponding to the location information of the identified target terminal.

9. The beam control device of claim 8, wherein the data transmitter is configured to, in case that direct transmission of data to the target terminal is impossible, transmit the data to at least one of a relay, a small cell, an intelligent reflecting surface, and a WiFi access point.

10. The beam control device of claim 8, wherein the object identification and location extraction unit is configured to perform pre-processing of processing the obtained image information through a signal processing or machine learning technology and extract confidence information indicated by an error rate or a margin of error.
